(19) United States
(12) Patent Application Publication
(10) Pub. No.: US 2003/0025826 A1
(43) Pub. Date: Feb. 6, 2003

(54) Small image pickup module

(75) Inventor: Yasuo Nakajoh, Niiza-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/236,436

(22) Filed: Sep. 6, 2002

Related U.S. Application Data
(63) Continuation of application No. PCT/JP01/01227, filed on Feb. 21, 2001.

(30) Foreign Application Priority Data
Mar. 10, 2000 (JP) 2000-066971

(51) Int. Cl. H04N 5/225

(52) U.S. Cl. 348/374; 348/340

(57) ABSTRACT

The present invention provides a small image pickup module in which a structure, which mounts a lens-barrel body so as to enclose therein a semiconductor device chip for image pickup mounted on a substrate, is improved, and in which assembly work is easy and a reduction in costs is possible. In accordance with one aspect of the present invention, there is provided a small image pickup module comprising a substrate made from a nonmetal including a ceramic or the like, a semiconductor device chip for image pickup including a two-dimensional C-MOS image sensor or the like which is mounted to the substrate, a lens-barrel body which is attached as a reference on the substrate so as to enclose the semiconductor device chip for image pickup therein, and in which a diaphragm section and a lens fixing portion are press-formed integrally in that order from the distal end portion, and a lens which is mounted to the lens fixing portion of the lens-barrel body.

### CROSS-REFERENCE TO RELATED APPLICATIONS

This is a Continuation Application of PCT Application No. PCT/JP01/01227, filed Feb. 21, 2001, which was not published under PCT Article 21(2) in English.

This application is based upon and claims the benefit of priority from the prior Japanese Patent Application No. 2000-066971, filed Mar. 10, 2000, the entire contents of which are incorporated herein by reference.

### BACKGROUND OF THE INVENTION

1. Field of the Invention

The present invention relates to a small image pickup module, and in particular, to a small image pickup module in which a lens and a semiconductor device chip for image pickup are accommodated in one package and integrated.

2. Description of the Related Art

In recent years, the demand for small image sensor units has increased in various multimedia fields such as note-type personal computers, mobile phones and the like, and further, for image inputting equipment of information terminals such as monitoring cameras, video tape recorders and the like, and for in-vehicle applications or the like.

As a small image sensor unit suitable for this type of image inputting equipment, there is an image pickup module in which parts such as a solid-state image pickup device, a lens member, a filter, a diaphragm member and the like are accommodated in one package and integrated.

The image pickup module as a conventional image sensor unit has a structure in which, after a solid-state image pickup device is mounted to a substrate, the substrate is fixed in a package by screws, adhesion or the like, and a supporting frame holding a lens member is mounted on the above-described package.

Namely, because the image pickup module as the conventional image sensor unit has a structure as described above, the accuracy of the positional relationship of the lens with respect to the solid-state image pickup device cannot be sufficiently ensured.

In this way, the accuracy of positioning of the lens with respect to the solid-state image pickup device is inferior in the image pickup module as a conventional image sensor unit. Therefore, a movable type focal point adjusting mechanism carrying out focusing is built-into the package, each part is assembled in the package, and then focusing of the lens member with respect to the solid-state image pickup device is carried out by the focal point adjusting mechanism.

However, the task of focusing in which the movable type adjusting mechanism is operated after each part is assembled is necessary. Further, after the focus adjustment, fixing a lens-barrel member or the like is necessary.

If the movable type focus adjusting mechanism is provided, the structure tends to become complicated, and the image pickup module as the image sensor unit becomes large-sized.

Further, during the task of focusing, dust easily enters the unit from gaps of the movable portion of the focus adjusting mechanism, and a countermeasure therefor is necessary. For example, there is the need for focus adjustment to be carried out in a clean room or the like, which reduces productivity.

Moreover, if the movable focus adjusting mechanism receives vibration, shock or the like after completion of the product, there are the drawbacks that the focusing position is easily distorted and the reliability of the product is inferior.

Accordingly, a solid-state image pickup apparatus structured such that the positioning accuracy, in the optical axis direction, of a lens with respect to a solid-state image pickup device can be easily ensured is proposed in Jpn. Pat. Appln. KOKAI Publication No. 9-232548.

The solid-state image pickup apparatus is configured such that a plurality of positioning portions are formed in step-shapes at a single supporting member, and parts such as a solid-state image pickup device, a lens member, a filter, a diaphragm member and the like are individually attached to the individual positioning portions, thereby the respective members are positioned and fixed.

However, in such a solid-state image pickup apparatus, because the plurality of positioning portions are formed in step-shapes at the single supporting member, dimension errors between the respective steps directly and greatly affect the positioning accuracy of the respective members.

Moreover, in order to form the plurality of positioning portions in step-shapes at the single supporting member, management of the accuracy of the dimensions is difficult and errors occur easily. A high-level manufacturing technology is required to form the plurality of positioning portions in step-shapes at the one supporting member.

In particular, when the single supporting member is made from a ceramic, manufacture thereof is extremely difficult, and the product is high-priced.

Here, it is mainly considered to manufacture the supporting member by injection molding by using synthetic resin or the like as the raw material.

However, even if the supporting member is made by injection molding, it is thought that it is easy for the dimensional errors between the respective positioning portions which are stepped to be large, and that the errors also increase due to changes over time thereafter, and reliability of the product is inferior.

In particular, in uses such as in-vehicle use or the like, the reliability is insufficient.

Further, in Japanese Patent No. 2559986, a prior art is disclosed in which the substrate as described above is mounted by utilizing a spring effect using a side wall of an enclosure as a supporting member such as that described above.

However, in the prior art in accordance with Japanese Patent No. 2559986, there is the problem that joggling based on the creep phenomenon over time occurs.

Further, in Jpn. Pat. Appln. KOKAI Publication No. 10-41492, a prior art is disclosed in which a lens cap and a pedestal are positioned by a guide pin and fixed.

However, in the case of this structure, there are the problems that the lens cap and the guide pin are necessary, the structure is complicated, productivity is poor, and the manufacturing costs increase.

Namely, in the conventional solid-state image pickup apparatus as described above, there were the problems that errors, in the dimensions between the steps between the respective positioning portions, occur easily, and it is difficult to manage the dimensions, and the positioning accuracy, in the optical axis direction, of the lens with respect to the solid-state image pickup device cannot be sufficiently ensured.

Further, in the conventional solid-state image pickup apparatus as described above, the structure is complicated, the productivity is poor, the manufacturing costs increase, and it is a high-priced product.

### BRIEF SUMMARY OF THE INVETNION

An object of the present invention is to provide a small image pickup module which has been achieved in consideration of the above-described circumstances, and in which, in a structure in which a semiconductor device chip for image pickup including a two-dimensional C-MOS image sensor or the like is mounted on a substrate and a lens-barrel body or the like is mounted so as to cover it, assembly work is easy and a reduction in costs is possible due to the mounting structure being variously improved.

In order to achieve the above object, according to the present invention, there is provided,

(1) a small image pickup module comprising:

a substrate made from a nonmetal including a ceramic or the like;

a semiconductor device chip for image pickup including a two-dimensional C-MOS image sensor or the like which is mounted to the substrate;

a lens-barrel body which is attached as a reference on the substrate so as to enclose the semiconductor device chip for image pickup therein, and in which a diaphragm section and a lens fixing portion are press-formed integrally in that order from the distal end portion; and

a lens which is mounted to the lens fixing portion of the lens-barrel body.

In order to achieve the above object, according to the present invention, there is provided,

(2) a small image pickup module comprising:

a substrate made from a nonmetal including a ceramic or the like;

a semiconductor device chip for image pickup including a two-dimensional C-MOS image sensor or the like which is mounted to the substrate;

a lens-barrel body which is attached as a reference on the substrate so as to enclose the semiconductor device chip for image pickup therein, and in which a diaphragm section and a lens fixing portion are press-formed integrally in that order from the distal end portion; and

a lens which is mounted to the lens fixing portion of the lens-barrel body,

wherein a coating for blocking infrared light is applied to the lens mounted to the lens fixing portion of the lens-barrel body.

In order to achieve the above object, according to the present invention, there is provided,

(3) a small image pickup module comprising:

a substrate made from a nonmetal including a ceramic or the like;

a semiconductor device chip for image pickup including a two-dimensional C-MOS image sensor or the like which is mounted to the substrate;

a lens-barrel body which is attached as a reference on the substrate so as to enclose the semiconductor device chip for image pickup therein, and in which a diaphragm section, a lens fixing portion, and an infrared light blocking filter fixing portion are press-formed integrally in that order from the distal end portion;

a lens which is mounted to the lens fixing portion of the lens-barrel body; and

an infrared light blocking filter which is mounted to the infrared light blocking filter fixing portion of the lens-barrel body.

In order to achieve the above object, according to the present invention, there is provided,

(4) a small image pickup module comprising:

a substrate made from a nonmetal including a ceramic or the like;

a semiconductor device chip for image pickup including a two-dimensional C-MOS image sensor or the like which is mounted to the substrate;

a lens-barrel body which is attached as a reference on the substrate so as to enclose the semiconductor device chip for image pickup therein, and in which a cover glass fixing portion, a diaphragm section, and a lens fixing portion are press-formed integrally in that order from the distal end portion;

a lens which is mounted to the lens fixing portion of the lens-barrel body; and

a cover glass which is mounted to the cover glass fixing portion of the lens-barrel body.

In order to achieve the above object, according to the present invention, there is provided,

(5) a small image pickup module comprising:

a substrate made from a nonmetal including a ceramic or the like;

a semiconductor device chip for image pickup including a two-dimensional C-MOS image sensor or the like which is mounted to the substrate; and

a lens-barrel body which is attached as a reference on the substrate so as to enclose the semiconductor device chip for image pickup therein, and in which at least a lens-barrel mounting portion is press-formed integrally at the distal end portion,

wherein the lens-barrel mounting portion of the lens-barrel body has a structure to which another lens-unit can be mounted.

In order to achieve the above object, according to the present invention, there is provided,

(6) a small image pickup module comprising:

a substrate made from a nonmetal including a ceramic or the like;

a semiconductor device chip for image pickup including a two-dimensional C-MOS image sensor or the like which is mounted to the substrate;

a lens-barrel body which is attached as a reference on the substrate so as to enclose the semiconductor device chip for image pickup therein, and in which a lens-barrel mounting portion and an infrared light blocking filter fixing portion are press-formed integrally in that order from the distal end portion; and

an infrared light blocking filter which is mounted to the infrared light blocking filter fixing portion of the lens-barrel body,

wherein the lens-barrel mounting portion of the lens-barrel body has a structure to which another lens-unit can be mounted.

In order to achieve the above object, according to the present invention, there is provided,

(7) a small image pickup module comprising:

a substrate made from a nonmetal including a ceramic or the like;

a semiconductor device chip for image pickup including a two-dimensional C-MOS image sensor or the like which is mounted to the substrate;

a lens-barrel body which is attached as a reference on the substrate so as to enclose the semiconductor device chip for image pickup therein, and in which a lens-barrel mounting portion, a cover glass fixing portion, and a diaphragm section are press-formed integrally in that order from the distal end portion; and

a cover glass which is mounted to the cover glass fixing portion of the lens-barrel body,

wherein the lens-barrel mounting portion of the lens-barrel body has a structure to which another lens-unit can be mounted, and

the cover glass is disposed at a front surface of the diaphragm section of the lens-barrel body.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the present invention, and together with the general description given above and the detailed description of the embodiments given below, serve to explain the principles of the present invention.

FIG. 1 is a cross-sectional view showing a schematic structure of a small image pickup module according to a first embodiment of the present invention.

FIG. 2 is a cross-sectional view showing a schematic structure of a small image pickup module according to a second embodiment of the present invention.

FIG. 3 is a cross-sectional view showing a schematic structure of a small image pickup module according to a third embodiment of the present invention.

FIG. 4 is a cross-sectional view showing a schematic structure of a small image pickup module according to a fourth embodiment of the present invention.

FIG. 5 is a cross-sectional view showing a schematic structure of a small image pickup module according to a fifth embodiment of the present invention.

FIG. 6 is a cross-sectional view showing a schematic structure of a small image pickup module according to a sixth embodiment of the present invention.

FIG. 7 is a cross-sectional view showing a schematic structure of a small image pickup module according to a seventh embodiment of the present invention.

### DETAILED DESCRIPTION OF THE INVENTION

Hereinafter, respective embodiments of the present invention will be described by using the figures.

(First Embodiment)

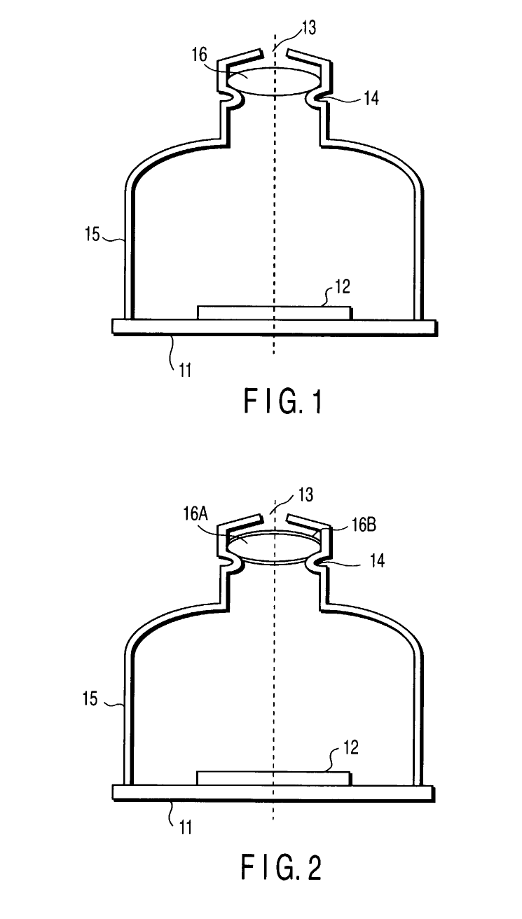

FIG. 1 is a cross-sectional view showing a structure of a small image pickup module according to a first embodiment of the present invention.

Namely, as shown in FIG. 1, the small image pickup module according to the first embodiment of the present invention comprises, as the basic structure: a substrate 11 made from a nonmetal including a ceramic or the like; a semiconductor device chip 12 for image pickup including a two-dimensional C-MOS image sensor or the like to be mounted to the nonmetal substrate 11; a lens-barrel body 15 which is attached as a reference on the nonmetal substrate 11 so as to enclose the semiconductor device chip 12 for image pickup therein, and in which a diaphragm section 13 and a lens fixing portion 14 are press-formed integrally in that order from the distal end portion; and a lens 16 to be mounted to the lens fixing portion 14 of the lens-barrel body 15.

Here, it is assumed that, there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the nonmetal substrate 11 made from ceramic is a plate-shaped structure having a round or rectangular shape and a uniform thickness in which a raw material of an integral bulk material is calcinated, and the top surface thereof is formed so as to be uniformly flat.

The small image pickup module thus structured according to the first embodiment of the present invention operates such that, for example, a digital or analog image signal is outputted by image-forming a photographed object image on the sensor section at the semiconductor device chip 12 for image pickup on the nonmetal substrate 11 via the diaphragm section 13 and the lens 16, and by photoelectrically converting the image.

Further, in the small image pickup module thus structured according to the first embodiment of the present invention, a package in which a two-dimensional sensor in accordance with a prior art is independently housed can be omitted. A reduction in cost and an improvement of mounting performance can be attempted while improving the optical performance, and in addition, there are the following features.

That is, even if the package as a conventional lens-barrel body can house the sensor section, as a structural problem, it is difficult for a lens and a diaphragm to be accurately mounted even in a lens optical system which makes the focal point match the sensor section and image-forms a photographed object image. Therefore, it is difficult to integrally mount them.

Here, in the first embodiment of the present invention, a desired accuracy can be ensured by press molding (sheeting) by using the lens-barrel body 15 in which the diaphragm section 13 and the lens fixing portion 14 are integrally press-molded. Therefore, it is possible to accurately mount the lens 16 and the diaphragm, and a reduction in cost is also possible.

(Second Embodiment)

FIG. 2 is a cross-sectional view showing a structure of a small image pickup module according to a second embodiment of the present invention.

Namely, as shown in FIG. 2, the small image pickup module according to the second embodiment of the present invention comprises, as the basic structure: the substrate 11 made from a nonmetal including a ceramic or the like; the semiconductor device chip 12 for image pickup including a two-dimensional C-MOS image sensor or the like to be mounted to the nonmetal substrate 11; the lens-barrel body 15 which is attached as a reference on the nonmetal substrate 11 so as to enclose the semiconductor device chip 12 for image pickup therein, and in which the diaphragm section 13 and the lens fixing portion 14 are press-formed integrally in that order from the distal end portion; and a lens 16A to be mounted to the lens fixing portion 14 of the lens-barrel 15.

In this case, the lens 16A to be mounted to the lens fixing portion 14 of the lens-barrel body 15 is characterized by being used also as a filter for blocking infrared light due to a coating 16B for blocking infrared light being applied thereto.

Here, it is assumed that, there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the ceramic substrate 11 is a plate-shaped structure having a round or rectangular shape and a uniform thickness in which a raw material of an integral bulk material is calcinated, and the top surface thereof is formed so as to be uniformly flat.

The small image pickup module thus structured according to the second embodiment of the present invention operates such that, for example, a digital or analog image signal is outputted by image-forming a photographed object image on the sensor section at the semiconductor device chip 12 for image pickup on the nonmetal substrate 11 via the lens 16A also serving as a filter for blocking infrared light due to the coating 16B for blocking infrared light being applied on the lens 16A to be mounted to the lens fixing portion 14 of the lens-barrel body 15 in which the diaphragm section 13 and the lens fixing portion 14 are integrally press-molded, and by photoelectrically converting the image.

Further, in the small image pickup module thus strucured according to the second embodiment of the present invention, a package in which a two-dimensional sensor of a prior art is independently housed can be omitted. A reduction in cost and an improvement of mounting performance can be attempted while improving the optical performance, and in addition, there are the following features.

Namely, even if the package as a conventional lens-barrel body can house the sensor section, as a structural problem, it is difficult for a lens and a diaphragm to be accurately mounted even in a lens optical system which makes the focal point match the sensor section and image-forms a photographed object image. Therefore, it is difficult to integrally mount them.

Here, in the second embodiment of the present invention, a desired accuracy can be ensured by press molding (sheeting) by using the lens-barrel body 15 in which the diaphragm section 13 and the lens fixing portion 14 are integrally press-molded. Therefore, it is possible to accurately mount the lens 16A also serving as a filter for blocking infrared light and the diaphragm, and a reduction in costs is also possible.

Further, in the second embodiment of the present invention, the lens 16A to be mounted to the lens fixing portion 14 of the lens-barrel body 15 is also used as the filter for blocking infrared light by the coating 16B for blocking infrared light being applied thereto. Therefore, it is possible to structure the optical system simply, and further, a reduction in costs is also possible.

(Third Embodiment)

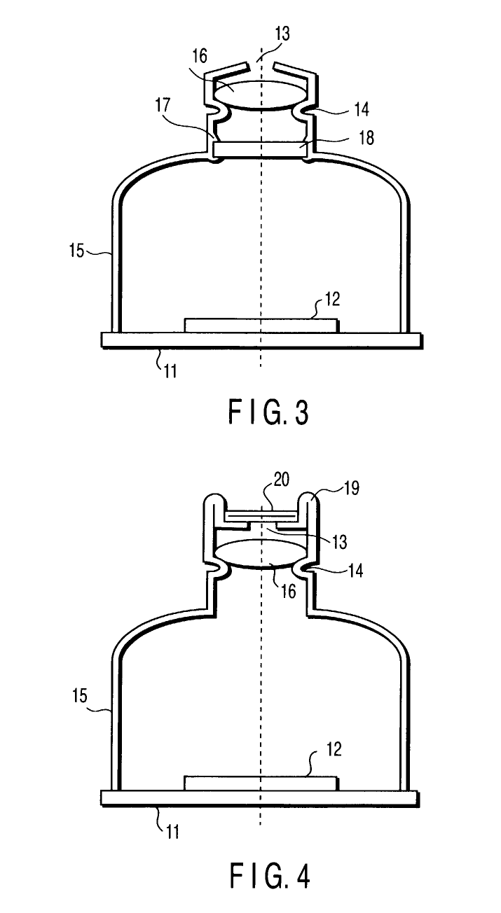

FIG. 3 is a cross-sectional view showing a structure of a small image pickup module according to a third embodiment of the present invention.

Namely, as shown in FIG. 3, the small image pickup module according to the third embodiment of the present invention comprises, as the basic structure: the substrate 11 made from a nonmetal including a ceramic or the like; the semiconductor device chip 12 for image pickup including a two-dimensional C-MOS image sensor or the like to be mounted to the nonmetal substrate 11; the lens-barrel body 15 which is attached as a reference on the nonmetal substrate 11 so as to enclose the semiconductor device chip 12 for image pickup therein, and in which the diaphragm section 13 and the lens fixing portion 14 and an infrared light blocking filter fixing portion 17 are integrally press-formed in that order from the distal end portion; the lens 16 to be mounted to the lens fixing portion 14 of the lens-barrel 15; and an infrared light blocking filter 18 to be mounted to the infrared light blocking filter fixing portion 17 of the lens-barrel body 15.

Here, it is assumed that, there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the ceramic substrate 11 is a plate-shaped structure having a round or rectangular shape and a uniform thickness in which a raw material of an integral bulk material is calcinated, and the top surface thereof is formed so as to be uniformly flat.

The small image pickup module thus structured according to the third embodiment of the present invention operates such that, for example, a digital or analog image signal is outputted by image-forming a photographed object image on the sensor section at the semiconductor device chip 12 for image pickup on the nonmetal substrate 11 via the diaphragm section 13, the lens 16, and the infrared light blocking filter 18, and by photoelectrically converting the image.

Further, in the small image pickup module according to the third embodiment of the present invention structured as described above, a package in which a two-dimensional sensor in accordance with a prior art is independently housed can be omitted. A reduction in cost and an improvement of mounting performance can be attempted while improving the optical performance, and in addition, there are the following features.

Namely, even if the package as a conventional lens-barrel body can house the sensor section, as a structural problem, it is difficult for an infrared light blocking filter, a lens, and a diaphragm to be accurately mounted even in a lens optical system, which includes the infrared light blocking filter and which makes the focal point match the sensor section and image-forms a photographed object image. Therefore, it is difficult to integrally mount them.

Here, in the third embodiment of the present invention, a desired accuracy can be ensured by press molding (sheeting) by using the lens-barrel body 15 in which the diaphragm section 13, the lens fixing portion 14, and the infrared light blocking filter fixing portion 17 are integrally press-molded. Therefore, it is possible to accurately mount the lens 16, the infrared blocking filter 17, and the diaphragm, and a reduction in costs is also possible.

(Fourth Embodiment)

FIG. 4 is a cross-sectional view showing a structure of a small image pickup module according to a fourth embodiment of the present invention.

Namely, as shown in FIG. 4, the small image pickup module according to the fourth embodiment of the present invention comprises, as the basic structure: the substrate 11 made from a nonmetal including a ceramic or the like; the semiconductor device chip 12 for image pickup including a two-dimensional C-MOS image sensor or the like to be mounted to the nonmetal substrate 11; the lens-barrel body 15 which is attached as a reference on the nonmetal substrate 11 so as to enclose the semiconductor device chip 12 for image pickup therein, and in which a cover glass fixing portion 19, the diaphragm section 13, and the lens fixing portion 14 are integrally press-formed in that order from the distal end portion; the lens 16 to be mounted to the lens fixing portion 14 of the lens-barrel body 15; and a cover glass 20 to be mounted to the cover glass fixing portion 19 of the lens-barrel body 15.

Here, it is assumed there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the ceramic substrate 11 is a plate-shaped structure having a round or rectangular shape and a uniform thickness in which a raw material of an integral bulk material is calcinated, and the top surface thereof is formed so as to be uniformly flat.

The small image pickup module thus structured according to the fourth embodiment of the present invention operates such that, for example, a digital or analog image signal is outputted by image-forming a photographed object image on the sensor section at the semiconductor device chip 12 for image pickup on the nonmetal substrate 11 via the cover glass 20, the diaphragm section 13, and the lens 16, and by photoelectrically converting the image.

Further, in the small image pickup module according to the fourth embodiment of the present invention structured as described above, a package in which a two-dimensional sensor in accordance with a prior art is independently housed can be omitted. A reduction in cost and an improvement of mounting performance can be attempted while improving the optical performance, and in addition, there are the following features.

Namely, even if the package as a conventional lens-barrel body can house the sensor section, as a structural problem, it is difficult for a cover glass, a lens, and a diaphragm to be accurately mounted even in a lens optical system, which includes the cover glass and which makes the focal point match the sensor section and image-forms a photographed object image. Therefore, it is difficult to integrally mount them.

Here, in the fourth embodiment of the present invention, a desired accuracy can be ensured by press molding (sheeting) by using the lens-barrel body 15 in which the cover glass fixing portion 19, the diaphragm section 13, and the lens fixing portion 14 are integrally press-molded in that order from the distal end portion. Therefore, it is possible to accurately mount the cover glass 20, the lens 16, and the diaphragm, and it is also possible to reduce costs, improve durability, and reduce size.

(Fifth Embodiment)

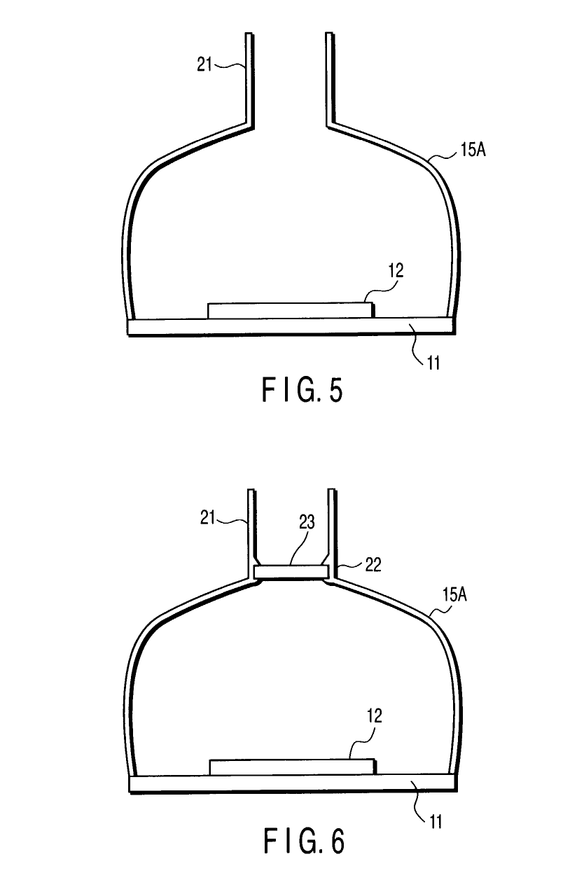

FIG. 5 is a cross-sectional view showing a structure of a small image pickup module according to a fifth embodiment of the present invention.

Namely, as shown in FIG. 5, the small image pickup module according to the fifth embodiment of the present invention comprises, as the basic structure: the substrate 11 made from a nonmetal including a ceramic or the like; the semiconductor device chip 12 for image pickup including a two-dimensional C-MOS image sensor or the like to be mounted to the nonmetal substrate 11; a lens-barrel body 15A which is attached as a reference on the nonmetal substrate 11 so as to enclose the semiconductor device chip 12 for image pickup therein, and in which at least a lens-barrel mounting portion 21 is integrally press-formed at the distal end portion.

In this case, there is the feature that the lens-barrel mounting portion 21 of the lens-barrel body 15A has a structure to which another lens-unit can be mounted.

Here, it is assumed that there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the ceramic substrate 11 is a plate-shaped structure having a round or rectangular shape and a uniform thickness in which a raw material of an integral bulk material is calcinated, and the top surface thereof is formed so as to be uniformly flat.

The small image pickup module thus structured according to the fifth embodiment of the present invention operates such that, for example, a digital or analog image signal is outputted by image-forming a photographed object image on the sensor section at the semiconductor device chip 12 for image pickup on the nonmetal substrate 11 via the diaphragm section, the lens and the like of another lens-unit (not shown) to be mounted to the lens-barrel mounting portion 21 of the above-described lens-barrel body 15A, and by photoelectrically converting the image.

Further, in the small image pickup module according to the fifth embodiment of the present invention structured as described above, a package in which a two-dimensional sensor in accordance with a prior art is independently housed can be omitted. A reduction in cost and an improvement of mounting performance can be attempted while improving the optical performance, and in addition, there are the following features.

Namely, even if the package as a conventional lens-barrel body can house the sensor section, as a structural problem, it is difficult for a lens-barrel mounting portion to be accurately mounted even in a lens optical system, which includes the lens-barrel mounting portion and which makes the focal point match the sensor section and image-forms a photographed object image. Therefore, it is difficult to integrally mount them.

Here, in the fifth embodiment of the present invention, a desired accuracy can be ensured by press molding (sheeting) by using the lens-barrel body 15A in which at least the lens-barrel mounting portion 21 is integrally press-molded at the distal end portion. Therefore, it is possible to accurately mount another lens-unit, and a reduction in costs is also possible.

(Sixth Embodiment)

FIG. 6 is a cross-sectional view showing a structure of a small image pickup module according to a sixth embodiment of the present invention.

Namely, as shown in FIG. 6, the small image pickup module according to the sixth embodiment of the present invention comprises, as the basic structure: the substrate 11 made from a nonmetal including a ceramic or the like; the semiconductor device chip 12 for image pickup including a two-dimensional C-MOS image sensor or the like to be mounted to the nonmetal substrate 11; the lens-barrel body 15A which is attached as a reference on the nonmetal substrate 11 so as to enclose the semiconductor device chip 12 for image pickup therein, and in which the lens-barrel mounting portion 21 and an infrared light blocking filter fixing portion 22 are integrally press-formed in that order from the distal end portion; and an infrared light blocking filter 23 to be mounted to the infrared light blocking filter fixing portion 22 of the lens-barrel body 15A.

In this case, there is the feature that the lens-barrel mounting portion 21 of the lens-barrel body 15A has a structure to which another lens-unit can be mounted.

Here, it is assumed that there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the ceramic substrate 11 is a plate-shaped structure having a round or rectangular shape and a uniform thickness in which a raw material of an integral bulk material is calcinated, and the top surface thereof is formed so as to be uniformly flat.

The small image pickup module thus structured according to the sixth embodiment of the present invention operates such that, for example, a digital or analog image signal is outputted by image-forming a photographed object image on the sensor section at the semiconductor device chip 12 for image pickup on the nonmetal substrate 11 via the diaphragm section, the lens and the like of another lens-unit (not shown) to be mounted to the lens-barrel mounting portion 21 of the above-described lens-barrel body 15A, and the infrared light blocking filter 23 mounted to the infrared light blocking filter fixing portion 22 of the lens-barrel body 15A, and by photoelectrically converting the image.

Further, in the small image pickup module according to the sixth embodiment of the present invention structured as described above, a package in which a two-dimensional sensor in accordance with a prior art is independently housed can be omitted. A reduction in cost and an improvement of mounting performance can be attempted while improving the optical performance, and in addition, there are the following features.

Namely, even if the package as a conventional lens-barrel body can house the sensor section, as a structural problem, it is difficult for a lens-barrel mounting portion to be accurately mounted even in a lens optical system, which includes the lens-barrel mounting portion and the infrared light shading filter and which makes the focal point match the sensor section and image-forms a photographed object image. Therefore, it is difficult to integrally mount them.

Here, in the sixth embodiment of the present invention, a desired accuracy can be ensured by press molding (sheeting) by using the lens-barrel body 15A in which at least the lens-barrel mounting portion 21 and the infrared light blocking filter fixing portion 22 are integrally press-molded at the distal end portion. Therefore, substantially, it is possible to accurately mount another lens-unit and the infrared light blocking filter 23, and it is also possible to attempt to reduce costs, improve durability, and reduce size.

(Seventh Embodiment)

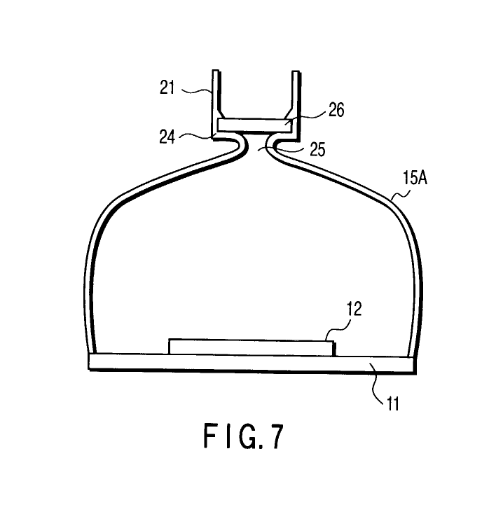

FIG. 7 is a cross-sectional view showing a structure of a small image pickup module according to a seventh embodiment of the present invention.

Namely, as shown in FIG. 7, the small image pickup module according to the seventh embodiment of the present invention comprises, as the basic structure: the substrate 11 made from a nonmetal including a ceramic or the like; the semiconductor device chip 12 for image pickup including a two-dimensional C-MOS image sensor or the like to be mounted to the nonmetal substrate 11; the lens-barrel body 15A which is attached as a reference on the nonmetal substrate 11 so as to enclose the semiconductor device chip 12 for image pickup therein, and in which the lens-barrel mounting portion 21, the cover glass fixing portion 24, and an diaphragm section 25 are integrally press-formed in that order from the distal end portion; and a cover glass 26 to be mounted to the cover glass fixing portion 24 of the lens-barrel body 15A.

In this case, there is the feature that the lens-barrel mounting portion 21 of the lens-barrel body 15A has a structure to which another lens-unit can be mounted.

Here, it is assumed that there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an A/D converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the ceramic substrate 11 is a plate-shaped structure having a round or rectangular shape and a uniform thickness in which a raw material of an integral bulk material is calcinated, and the top surface thereof is formed so as to be uniformly flat.

The small image pickup module thus structured according to the seventh embodiment of the present invention operates such that, for example, a digital or analog image signal is outputted by image-forming a photographed object image on the sensor section at the semiconductor device chip 12 for image pickup on the nonmetal substrate 11 via the diaphragm section, the lens and the like of another lens-unit (not shown) to be mounted to the lens-barrel mounting portion 21 of the above-described lens-barrel body 15A and the cover glass 26 to be mounted to the cover glass fixing portion 24 of the lens-barrel body 15A, and by photoelectrically converting the image.

Further, in the small image pickup module according to the seventh embodiment of the present invention structured as described above, a package in which a two-dimensional sensor in accordance with a prior art is independently housed can be omitted. A reduction in cost and an improvement of mounting performance can be attempted while improving the optical performance, and in addition, there are the following features.

Namely, even if the package as a conventional lens-barrel body can house the sensor section, as a structural problem, it is difficult for a lens-barrel mounting portion and a cover glass to be accurately mounted even in a lens optical system, which includes the lens-barrel mounting portion and the cover glass and which makes the focal point match the sensor section and image-forms a photographed object image. Therefore, it is difficult to integrally mount them.

Here, in the seventh embodiment of the present invention, a desired accuracy can be ensured by press molding (sheeting) by using the lens-barrel body 15A in which at least the lens-barrel mounting portion 21 and the cover glass fixing portion 24 are integrally press-molded at the distal end portion. Therefore, it is possible to accurately mount another lens-unit and the cover glass 26, and it is also possible to attempt to reduce costs, improve durability, and reduce size.

Note that the cover glasses 20 and 26 may be used as the infrared light blocking filter.

Further, in accordance with the present invention recited in claim 1 described later, a package, in which a two-dimensional sensor in accordance with a prior art is independently housed, can be omitted. A reduction in cost and improvement of mounting performance can be attempted while improving the optical performance, and in addition, there are features as follows.

Namely, even if the package as a conventional lens-barrel body can house the sensor section, as a structural problem, because it is difficult for the lens and the diaphragm to be accurately mounted even in a lens optical system which makes the focal point match the sensor section and image-forms a photographed object image, it is difficult to integrally mount them. However, in the present invention recited in claim 1 described later, the desired accuracy can be ensured by press molding (sheeting) by using the lens-barrel body 15 in which the diaphragm section 13 and the lens fixing portion 14 are integrally press-molded. Therefore, substantially, it is possible to accurately mount the lens 16 and the diaphragm, and a reduction in costs can be attempted.

Further, in accordance with the present invention recited in claim 2 described later, a package, in which a two-dimensional sensor in accordance with a prior art is independently housed, can be omitted. A reduction in cost and improvement of mounting performance can be attempted while improving the optical performance, and in addition, there are features as follows.

Namely, even if the package as a conventional lens-barrel body can house the sensor section, as a structural problem, because it is difficult for the lens and the diaphragm to be accurately mounted even in a lens optical system which makes the focal point match the sensor section and image-forms a photographed object image, it is difficult to integrally mount them. However, in the present invention recited in claim 2 described later, the desired accuracy can be ensured by press molding (sheeting) by using the lens-barrel body 15 in which the diaphragm section 13 and the lens fixing portion 14 are integrally press-molded. Therefore, substantially, it is possible to accurately mount the lens 16A and the diaphragm, and a reduction in costs can be attempted.

Further, in accordance with the present invention recited in claim 2 described later, the lens 16A to be attached to the lens fixing portion of the above-described lens-barrel body is also used as the infrared light blocking filter by a coating for infrared light blocking being applied thereto, thereby can be simply structured. Further, a reduction in costs can be attempted.

Further, in accordance with the present invention recited in claim 3 described later, a package, in which a two-dimensional sensor in accordance with a prior art is independently housed, can be omitted. A reduction in cost and improvement of mounting performance can be attempted while improving the optical performance, and in addition, there are features as follows.

Namely, even if the package as a conventional lens-barrel body can house the sensor section, as a structural problem, because it is difficult for the infrared light blocking filter, the lens, and the diaphragm to be accurately mounted even in a lens optical system, which includes the infrared light blocking filter and which makes the focal point match the sensor section and image-forms a photographed object image, it is difficult to integrally mount them. However, in the present invention recited in claim 3 described later, the desired accuracy can be ensured by press molding (sheeting) by using the lens-barrel body 15 in which the diaphragm section 13, the lens fixing portion 14, and the infrared light blocking filter fixing portion 17 are integrally press-molded. Therefore, substantially, it is possible to accurately mount the lens 16, the infrared light blocking filter 17, and the diaphragm, and a reduction in costs can be attempted.

Further, in accordance with the present invention recited in claim 4 described later, a package, in which a two-dimensional sensor in accordance with a prior art is independently housed, can be omitted. A reduction in cost and improvement of mounting performance can be attempted while improving the optical performance, and in addition, there are features as follows.

Namely, even if the package as a conventional lens-barrel body can house the sensor section, as a structural problem, because it is difficult for the cover glass, the lens, and the diaphragm to be accurately mounted even in a lens optical system, which includes the cover glass and which makes the focal point match the sensor section and image-forms a photographed object image, it is difficult to integrally mount them. However, in the present invention recited in claim 4 described later, the desired accuracy can be ensured by press molding (sheeting) by using the lens-barrel body 15 in which the cover glass fixing portion 19, the diaphragm section 13, and the lens fixing portion 14 are integrally press-molded. Therefore, substantially, it is possible to accurately mount the cover glass 20, the lens 16 and the diaphragm, and to attempt to reduce costs, improve durability and reduce size.

Further, in accordance with the present invention recited in claim 5 described later, a package, in which a two-dimensional sensor in accordance with a prior art is independently housed, can be omitted. A reduction in cost and improvement of mounting performance can be attempted while improving the optical performance, and in addition, there are features as follows:

Namely, even if the package as a conventional lens-barrel body can house the sensor section, as a structural problem, because it is difficult for the lens-barrel mounting portion to be accurately mounted even in a lens optical system, which includes the lens-barrel mounting portion and which makes the focal point match the sensor section and image-forms a photographed object image, it is difficult to integrally mount them. However, in the present invention recited in claim 5 described later, the desired accuracy can be ensured by press molding (sheeting) by using the lens-barrel body 15A in which at least the lens-barrel mounting portion 21 is integrally press-molded at the distal end portion. Therefore, it is possible to accurately mount another lens-unit, and a reduction in costs can be attempted.

Further, in accordance with the present invention recited in claim 6 described later, a package, in which a two-dimensional sensor in accordance with a prior art is independently housed, can be omitted. A reduction in cost and improvement of mounting performance can be attempted while improving the optical performance, and in addition, there are features as follows.

Namely, even if the package as a conventional lens-barrel body can house the sensor section, as a structural problem, because it is difficult for the lens-barrel mounting portion and the infrared light blocking filter to be accurately mounted even in a lens optical system, which includes the lens-barrel mounting portion and the infrared light blocking filter and which makes the focal point match the sensor section and image-forms a photographed object image, it is difficult to integrally mount them. However, in the present invention recited in claim 6 described later, the desired accuracy can be ensured by press molding (sheeting) by using the lens-barrel body 15A in which at least the lens-barrel mounting portion 21 and the infrared light blocking filter fixing portion 22 are integrally press-molded at the distal end portion. Therefore, it is possible to accurately mount another lens-unit and the infrared light blocking filter 23, and a reduction in costs can be attempted.

Further, in accordance with the present invention recited in claim 7 described later, a package, in which a two-dimensional sensor in accordance with a prior art is independently housed, can be omitted. A reduction in cost and improvement of mounting performance can be attempted while improving the optical performance, and in addition, there are features as follows.

Namely, even if the package as a conventional lens-barrel body can house the sensor section, as a structural problem, because it is difficult for the lens-barrel mounting portion and the cover glass to be accurately mounted even in a lens optical system, which includes the lens-barrel mounting portion and the cover glass and which makes the focal point match the sensor section and image-forms a photographed object image, it is difficult to integrally mount them. However, in the present invention recited in claim 7 described later, the desired accuracy can be ensured by press molding (sheeting) by using the lens-barrel body 15A in which at least the lens-barrel mounting portion 21 and the cover glass fixing portion 24 are integrally press-molded at the distal end portion. Therefore, substantially, it is possible to accurately mount another lens-unit and the cover glass 26, and to attempt to reduce costs, improve durability and reduce size.

In particular, in a lens-barrel structure formed by metal press molding, sufficient reliability of the airtight sealing performance and the temperature-humidity resistance can be presented at a low cost.

Note that, as described above, in the prior art in accordance with Japanese Patent No. 2559986, since it is mounted to the substrate by utilizing a spring effect using a side wall of an enclosure, there is the problem that joggling based on the creep phenomenon over time occurs. However, in the present invention according to claim 2 described later, the above-described lens-barrel body is mounted to the substrate by using an adhesive in order to basically prevent a load from being applied to the side wall. Therefore, it is possible to overcome the problem of joggling based on the creep phenomenon over time occurring.

Further, as described above, in the prior art in accordance with Jpn. Pat. Appln. KOKAI Publication No. 9-232548, since all are structured from a single member, there are the problems that the shape and the structure are complicated, the productivity is poor, and the manufacturing costs increase. However, in the present invention recited in claims 1 to 4 described later, by using the lens-barrel formed by press molding, the shape and the structure of the member are simple, the productivity is good, and a reduction in manufacturing costs can be attempted.

Further, as described above, in the prior art in accordance with Jpn. Pat. Appin. KOKOKU Publication No. 8-28435, since there is a structure in which a metal can and a lens molten glass are adhered, there is the need to consider the wetting characteristic of the molten glass. However, in the present invention recited in claims 1 to 7 described later, by basically using a lens which has already been molded, there is no need to consider the wetting characteristic of a molten glass.

Further, as described above, in the prior art in accordance with Jpn. Pat. Appln. KOKAI Publication No. 10-41492, since it is a structure in which a lens cap and a pedestal are positioned and fixed by a guide pin, the lens cap and the guide pin are necessary, and there are the problems that the structure is complicated, the productivity is poor, and the manufacturing costs increase. However, in the present invention recited in claims 1 to 7 described later, the lens cap is basically not necessary, and the guide pin is not always necessary.

Accordingly, as described above, in accordance with the present invention, in a structure in which a semiconductor device chip for image pickup, including a two-dimensional C-MOS image sensor or the like, is mounted on a substrate made from a nonmetal including a ceramic or the like, and a lens-barrel is mounted so as to cover it, the mounting structure is variously improved. Therefore, it is possible to provide a small image pickup module in which the assembly work is easy and a reduction in costs is possible.

Further, in accordance with the present invention, a small image pickup module, which can realize the high reliability (vibration resistance, temperature and humidity resistance and the like) required for in-vehicle use or the like can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A small image pickup module comprising:
a substrate made from a nonmetal including a ceramic or the like;
a semiconductor device chip for image pickup including a two-dimensional C-MOS image sensor or the like which is mounted to the substrate;
a lens-barrel body which is attached as a reference on the substrate so as to enclose the semiconductor device chip for image pickup therein, and in which a diaphragm section and a lens fixing portion are press-formed integrally in that order from the distal end portion; and
a lens which is mounted to the lens fixing portion of the lens-barrel body.

2. A small image pickup module comprising:
a substrate made from a nonmetal including a ceramic or the like;
a semiconductor device chip for image pickup including a two-dimensional C-MOS image sensor or the like which is mounted to the substrate;
a lens-barrel body which is attached as a reference on the substrate so as to enclose the semiconductor device chip for image pickup therein, and in which a diaphragm section and a lens fixing portion are press-formed integrally in that order from the distal end portion; and
a lens which is mounted to the lens fixing portion of the lens-barrel body,
wherein a coating for blocking infrared light is applied to the lens mounted to the lens fixing portion of the lens-barrel body.

3. A small image pickup module comprising:
a substrate made from a nonmetal including a ceramic or the like;
a semiconductor device chip for image pickup including a two-dimensional C-MOS image sensor or the like which is mounted to the substrate;
a lens-barrel body which is attached as a reference on the substrate so as to enclose the semiconductor device chip for image pickup therein, and in which a diaphragm section, a lens fixing portion, and an infrared light blocking filter fixing portion are press-formed integrally in that order from the distal end portion;
a lens which is mounted to the lens fixing portion of the lens-barrel body; and
an infrared light blocking filter which is mounted to the infrared light blocking filter fixing portion of the lens-barrel body.

4. A small image pickup module comprising:
a substrate made from a nonmetal including a ceramic or the like;
a semiconductor device chip for image pickup including a two-dimensional C-MOS image sensor or the like which is mounted to the substrate;
a lens-barrel body which is attached as a reference on the substrate so as to enclose the semiconductor device chip for image pickup therein, and in which a cover glass fixing portion, a diaphragm section, and a lens fixing portion are press-formed integrally in that order from the distal end portion;
a lens which is mounted to the lens fixing portion of the lens-barrel body; and
a cover glass which is mounted to the cover glass fixing portion of the lens-barrel body.

5. A small image pickup module comprising:
a substrate made from a nonmetal including a ceramic or the like;
a semiconductor device chip for image pickup including a two-dimensional C-MOS image sensor or the like which is mounted to the substrate; and
a lens-barrel body which is attached as a reference on the substrate so as to enclose the semiconductor device chip for image pickup therein, and in which at least a lens-barrel mounting portion is press-formed integrally at the distal end portion,
wherein the lens-barrel mounting portion of the lens-barrel body has a structure to which another lens-unit can be mounted.

6. A small image pickup module comprising:
a substrate made from a nonmetal including a ceramic or the like;
a semiconductor device chip for image pickup including a two-dimensional C-MOS image sensor or the like which is mounted to the substrate;
a lens-barrel body which is attached as a reference on the substrate so as to enclose the semiconductor device chip for image pickup therein, and in which a lens-barrel mounting portion and an infrared light blocking filter fixing portion are press-formed integrally in that order from the distal end portion; and
an infrared light blocking filter which is mounted to the infrared light blocking filter fixing portion of the lens-barrel body,
wherein the lens-barrel mounting portion of the lens-barrel body has a structure to which another lens-unit can be mounted.

7. A small image pickup module comprising:
a substrate made from a nonmetal including a ceramic or the like;
a semiconductor device chip for image pickup including a two-dimensional C-MOS image sensor or the like which is mounted to the substrate;
a lens-barrel body which is attached as a reference on the substrate so as to enclose the semiconductor device chip for image pickup therein, and in which a lens-barrel mounting portion, a cover glass fixing portion, and a diaphragm section are press-formed integrally in that order from the distal end portion; and
a cover glass which is mounted to the cover glass fixing portion of the lens-barrel body,
wherein the lens-barrel mounting portion of the lens-barrel body has a structure to which another lens-unit can be mounted, and
the cover glass is disposed at a front surface of the diaphragm section of the lens-barrel body.
